(19) United States
(12) Patent Application Publication
(10) Pub. No.: US 2012/0211320 A1
(43) Pub. Date: Aug. 23, 2012

(54) SYNCHRONIZER SLEEVE FOR A TRANSMISSION AND METHOD OF MAKING

(76) Inventor: Jose Correa Neto, Campinas-Sao Paulo (BR)

(21) Appl. No.: 13/396,812

(22) Filed: Feb. 15, 2012

Related U.S. Application Data
(60) Provisional application No. 61/444,052, filed on Feb. 17, 2011.

(51) Int. Cl. F16D 23/02; B22F 3/00

(52) U.S. Cl. 192/53.3; 419/61

(57) ABSTRACT

A synchronizer sleeve for use in a transmission and method of making is disclosed herein. The synchronizer sleeve having: a plurality of gear teeth integrally formed on the inner diameter of the ring member, wherein the distal ends of the plurality of gear teeth extend from the inner diameter and comprise a portion of at least one of a pair of sides; wherein each of the distal ends of the plurality of gear teeth have a top portion, a bottom portion and a pair of opposing sides extending between the top portion and the bottom portion and each distal end is separated from each other by a recess located between each one of the pair of opposing sides; wherein no recess is formed adjacent to the top portion of the plurality of gear teeth; and wherein no secondary processing steps are required to reshape the synchronizer sleeve.

### BACKGROUND

This application claims the benefit of U.S. Provisional Patent Application Ser. No. 61/444,052, filed Feb. 17, 2011, the contents of which are incorporated herein by reference thereto.

Exemplary embodiments of the present invention relate to a synchronizer sleeve for a transmission and method of making a synchronizer sleeve.

Gear tooth profiles and other work piece tooth profiles are typically finished using hobbing, shaping, or grinding processes. All of which are capital intensive. The highest precision gears are ground which is very expensive.

Accordingly, it is desirable to provide high precision work pieces, gears or sleeves without associated costs.

### SUMMARY OF THE INVENTION

In accordance with an exemplary embodiment of the invention, a synchronizer sleeve for use in a transmission is provided. The synchronizer sleeve having: a ring member having an inner diameter and an outer periphery; a plurality of gear teeth integrally formed on the inner diameter of the ring member, wherein the distal ends of the plurality of gear teeth extend from the inner diameter and comprise a portion of at least one of a pair of sides of the ring member that extends from the inner diameter to the outer periphery; wherein each of the distal ends of the plurality of gear teeth have a top portion, a bottom portion and a pair of opposing sides extending between the top portion and the bottom portion and each distal end is separated from each other by a recess located between each one of the pair of opposing sides; wherein no recess is formed adjacent to the top portion of the plurality of gear teeth; and wherein the synchronizer sleeve is formed from a net shape, high density powder metal process wherein no secondary processing steps are required to reshape the synchronizer sleeve.

In another exemplary embodiment, a method for manufacturing a synchronizer sleeve is provided. The method comprising the steps of: forming the synchronizer sleeve by a powdered metal manufacturing process, wherein the synchronizer sleeve comprises a ring member with an inner diameter and an outer periphery, the ring member having a plurality of gear teeth integrally formed on the inner diameter of the ring member, wherein the distal ends of the plurality of gear teeth extend from the inner diameter and comprise a portion of at least one of a pair of sides of the ring member that extends from the inner diameter to the outer periphery; wherein each of the distal ends of the plurality of gear teeth have a top portion, a bottom portion and a pair of opposing sides extending between the top portion and the bottom portion and each distal end is separated from each other by a recess located between each one of the pair of opposing sides; wherein no recess is formed adjacent to the top portion of the plurality of gear teeth; and wherein the powdered metal manufacturing process is a net shape, high density powder metal process wherein no secondary processing steps are required to reshape the synchronizer sleeve.

Additional features and advantages of the various aspects of exemplary embodiments of the present invention will become more readily apparent from the following detailed description in conjunction with the drawings wherein like reference numerals refer to corresponding parts in the several views.

### BRIEF DESCRIPTION OF THE DRAWINGS

FIG. 1 is a partial view of a transmission with a synchronizer sleeve in accordance with an exemplary embodiment of the present invention;

FIGS. 2-2B are views of a synchronizer sleeve;

FIG. 3 is a partial perspective view of a synchronizer sleeve constructed in accordance with an exemplary embodiment of the present invention;

FIG. 4 is a partial perspective view of the gear or synchronizer ring configured to engage the synchronizer sleeve;

FIGS. 5 and 6 are views illustrating the gear or synchronizer ring of FIG. 4 engaging the synchronizer sleeve of FIG. 3; and

FIGS. 7-7B are views of the synchronizer sleeve and its engagement with a gear or synchronizer ring according to an embodiment of the present invention.

Although the drawings represent varied embodiments and features of the present invention, the drawings are not necessarily to scale and certain features may be exaggerated in order to illustrate and explain exemplary embodiments of the present invention. The exemplification set forth herein illustrates several aspects of the invention, in one form, and such exemplification is not to be construed as limiting the scope of the invention in any manner.

### DETAILED DESCRIPTION OF EXEMPLARY EMBODIMENTS

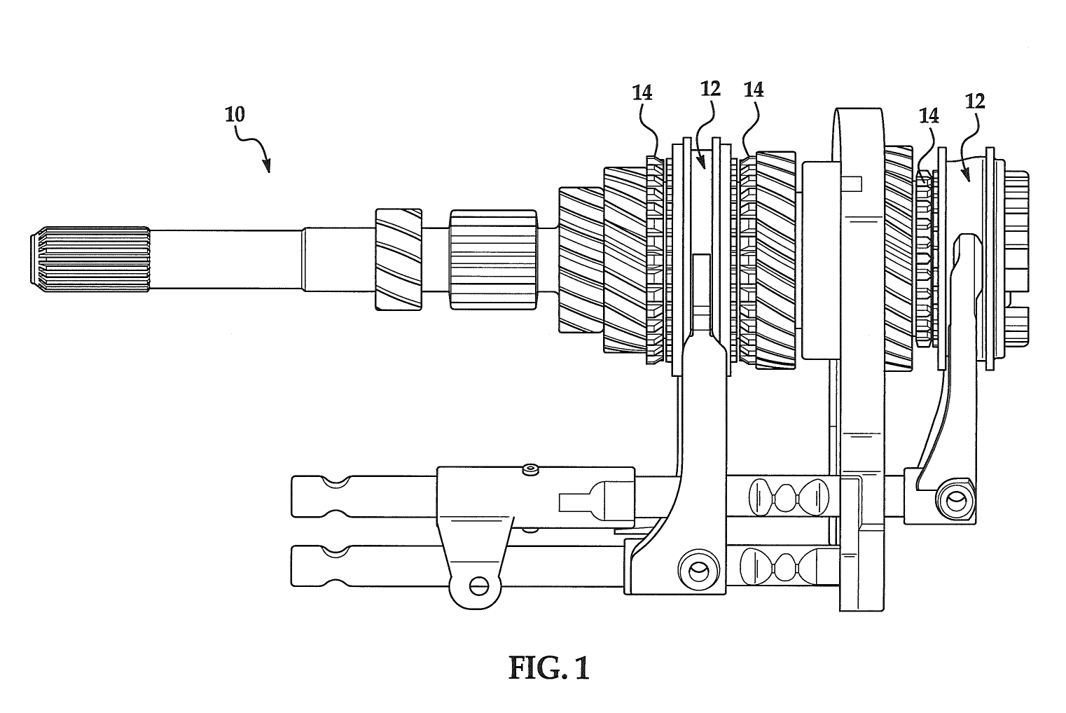

Most transmissions have a synchronizer sleeve to help shift gears and at the same time transfer rotational movement of one shaft to another. FIG. 1 illustrates a portion of a dual clutch transmission 10 with a pair of synchronizing sleeves 12, of course and depending on the transmission, the number of synchronizing sleeves may vary.

The synchronizing sleeves can be made out forged blanks that are fully machined or formed from a powdered metal process. In one exemplary embodiment of the present invention, the powdered metal process can eliminate some of the machining operations required in other designs by using a net shape process, as will be discussed herein.

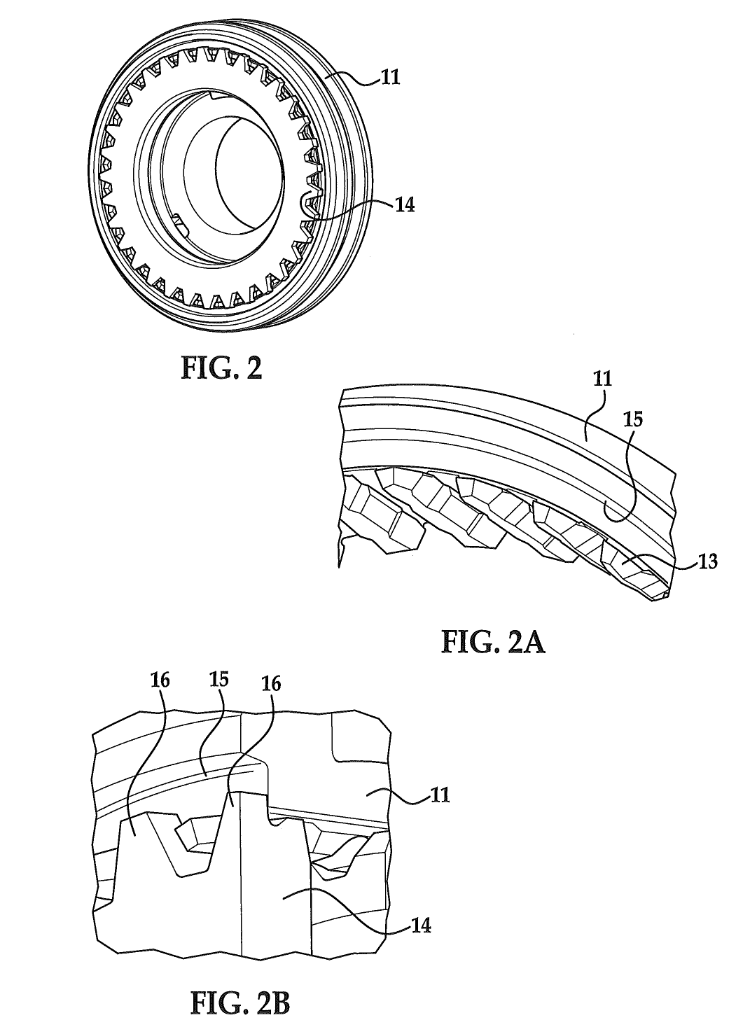

As illustrated in FIGS. 2-2B, a prior synchronizer sleeve 11 is shown engaging a gear or synchronizer ring 14 of the transmission. Here a plurality of teeth 16 of the gear or synchronizer ring are configured to be received within a plurality of teeth 13 cut into the synchronizer sleeve 11 in an interrupted fashion. In addition, a side cut 15 is also cut into a side portion of the synchronizer sleeve. This side cut and the teeth are machined from the blank formed into the illustrated synchronizer sleeve and as such, the machining process adds significant secondary costs to the formation of the illustrated synchronizer sleeve of FIGS. 2-2B. Moreover, this machining is a difficult process since the machining process generates burs that must be removed from the gear teeth and the process itself can cause damage to the gear teeth through cracks or breaks.

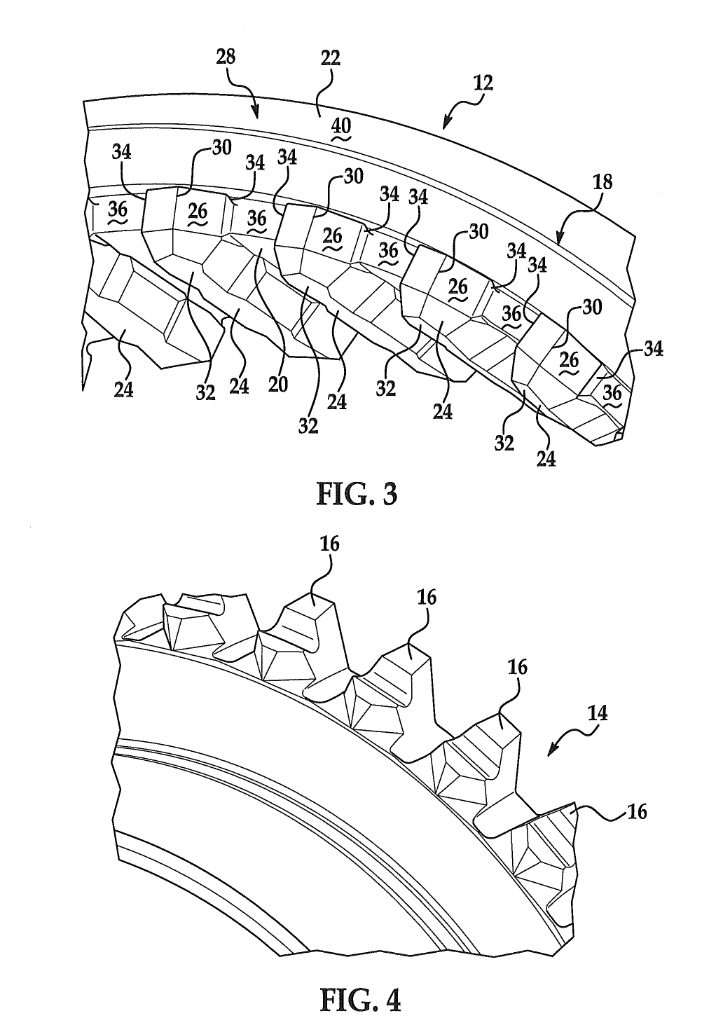

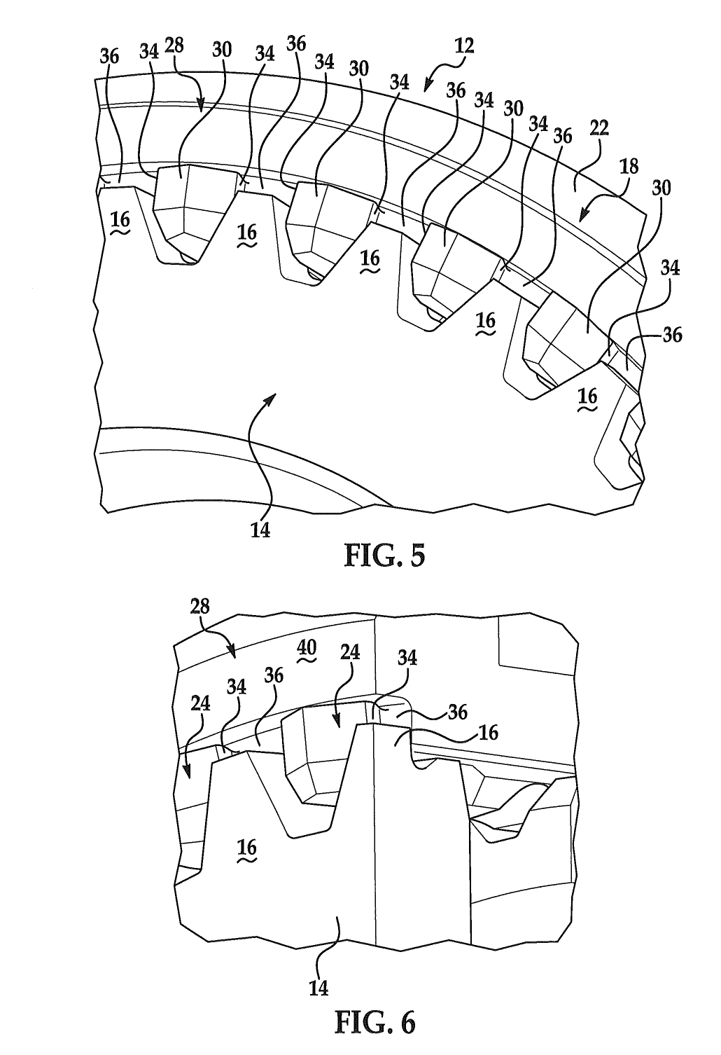

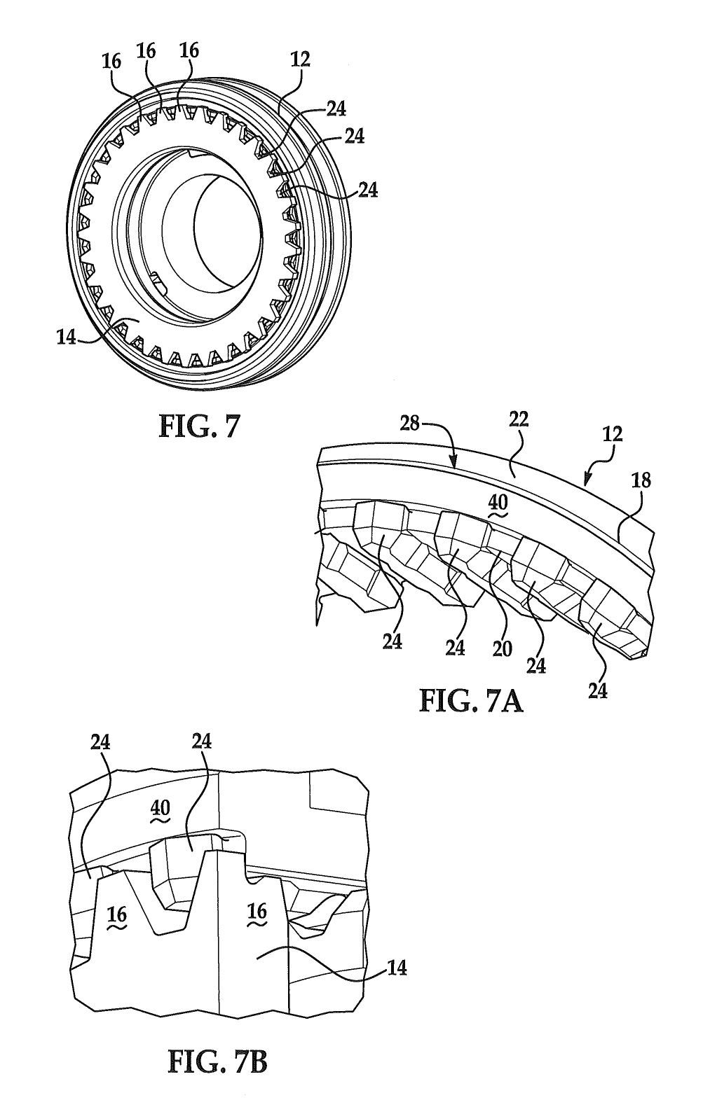

Referring now to FIGS. 3 and 5-7B, a synchronizer sleeve 12 formed in accordance with an embodiment of the present invention is illustrated. In one embodiment the synchronizer sleeve has a ring member 18 that is configured to have an inner diameter 20 and an outer periphery 22. The ring member has a plurality of gear teeth 24 each integrally formed on the inner diameter of the ring member. Each of the gear teeth has a distal end 26 that extends from the inner diameter and comprises a portion of at least one of a pair of sides 28 of the ring member that extends from the inner diameter to the outer periphery.

In one embodiment, the distal ends of the plurality of gear teeth are located on only one side of the synchronizer sleeve. In an alternative configuration, the distal ends of the plurality of gear teeth are located on both sides of the synchronizer sleeve.

Each of the distal ends of the plurality of gear teeth have a top portion 30, a bottom portion 32 and a pair of opposing sides 34 extending between the top portion and the bottom portion. In addition, each distal end is separated from each other by a recess 36 located between each one of the pair of opposing sides. Accordingly, each recess 36 is configured to provide an area into which a tooth 16 of gear or synchronizer ring 14 can be received.

As illustrated and in contrast to the configuration illustrated in FIGS. 2-2B, no recess is formed above the top portion and an outer sidewall 40 of the synchronizer sleeve extends from the top portion to the outer periphery of the ring member. By eliminating the side slot illustrated in FIGS. 2-2B, the manufacturing and/or forming of the synchronizer sleeve is simplified thus reducing the associated manufacturing costs.

In addition and by eliminating the side slot located above the top portion of the distal ends of the plurality of teeth a more robust design is provided and the same is less likely to be damaged during use and/or the associated manufacturing process.

In one configuration, the distal ends of the plurality of gear teeth are configured to have a chamfered surface that is angled downwardly towards the recess 36 located between each of the distal ends of the plurality of gear teeth.

In accordance with one exemplary embodiment of the present invention, one non-limiting process for forming the synchronizer sleeve illustrated in FIGS. 3 and 5-7B is from a powdered metal forming process wherein the sleeve is formed from a net shape powder metal part. Here the net shape part or synchronizer sleeve will be a high density net shape component that will not require a secondary process for surface densification and/or to form the final shape. Accordingly, the powder is positioned into a mold or passed through a die to a form the structure similar to that of the final product. During this process pressures are applied to the mold or die and if applicable, the green compact is then sintered to form the final product. In contrast, to the prior synchronizer sleeves no further secondary processes are required since the part is a high density net shaped formed part.

In one non-limiting exemplary embodiment, the net shape high density powder metal synchronizer sleeve is formed using a low carbon material (FLN2-4400 MPIF standard modified for low carbon or other equivalent material) to help the high densification during compaction (7.35 g/cc min or as otherwise necessary) and to also help the rolling process that adds a tapper on the tooth to avoid pull out after synchronization between the synchronizer ring and the synchronizer sleeve. (For example, max 0.3% of Graphite). Although specific examples are provided herein, exemplary embodiments contemplate values greater or less than the aforementioned values.

The low carbon material will help to move the material during the rolling process thereby avoiding under surface cracking on the powder metal component due to low hardness (˜140 HB). In addition and since the component will be carburized the low carbon will not affect the product hardness/performance. Again and although specific examples are provided herein, exemplary embodiments contemplate values greater or less than the aforementioned values.

In addition, exemplary embodiments of the present invention can be used with workpieces formed by other non-limiting net-shape gear-forming processes such as cast, forged and extruded gear forms or any other gear forming process.

As used herein, the terms “first,” “second,” and the like, herein do not denote any order, quantity, or importance, but rather are used to distinguish one element from another, and the terms “a” and “an” herein do not denote a limitation of quantity, but rather denote the presence of at least one of the referenced item. In addition, it is noted that the terms “bottom” and “top” are used herein, unless otherwise noted, merely for convenience of description, and are not limited to any one position or spatial orientation.

The modifier “about” used in connection with a quantity is inclusive of the stated value and has the meaning dictated by the context (e.g., includes the degree of error associated with measurement of the particular quantity).

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof Therefore, it is intended that the invention not be limited to the particular embodiment disclosed as the best mode contemplated for carrying out this invention, but that the invention will include all embodiments falling within the scope of the appended claims.

What is claimed is:

1. A synchronizer sleeve for use in a transmission, comprising:
a ring member having an inner diameter and an outer periphery;
a plurality of gear teeth integrally formed on the inner diameter of the ring member, wherein the distal ends of the plurality of gear teeth extend from the inner diameter and comprise a portion of at least one of a pair of sides of the ring member that extends from the inner diameter to the outer periphery;
wherein each of the distal ends of the plurality of gear teeth have a top portion, a bottom portion and a pair of opposing sides extending between the top portion and the bottom portion and each distal end is separated from each other by a recess located between each one of the pair of opposing sides;
wherein no recess is formed adjacent to the top portion of the plurality of gear teeth; and
wherein the synchronizer sleeve is formed from a net shape, high density powder metal process wherein no secondary processing steps are required to reshape the synchronizer sleeve.

2. The synchronizer sleeve as in claim 1, wherein the distal ends of the plurality of gear teeth are configured to have a chamfered surface.

3. The synchronizer sleeve as in claim 1, wherein the distal ends are the plurality of gear teeth comprise a portion of each pair of sides of the ring member.

4. The synchronizer sleeve as in claim 3, wherein the distal ends of the plurality of gear teeth are configured to have a chamfered surface.

5. A method for manufacturing a synchronizer sleeve of a transmission, comprising:
forming the synchronizer sleeve by a powdered metal manufacturing process, wherein the synchronizer sleeve comprises a ring member with an inner diameter and an outer periphery, the ring member having a plurality of gear teeth integrally formed on the inner diameter of the ring member, wherein the distal ends of the plurality of gear teeth extend from the inner diameter and comprise a portion of at least one of a pair of sides of the ring member that extends from the inner diameter to the outer periphery;
wherein each of the distal ends of the plurality of gear teeth have a top portion, a bottom portion and a pair of opposing sides extending between the top portion and the bottom portion and each distal end is separated from each other by a recess located between each one of the pair of opposing sides;
wherein no recess is formed adjacent to the top portion of the plurality of gear teeth; and
wherein the powdered metal manufacturing process is a net shape, high density powder metal process wherein no secondary processing steps are required to reshape the synchronizer sleeve.

6. The method as in claim 5, wherein the distal ends of the plurality of gear teeth are configured to have a chamfered surface.

7. The method as in claim 5, wherein the distal ends are the plurality of gear teeth comprise a portion of each pair of sides of the ring member.

8. The method as in claim 7, wherein the distal ends of the plurality of gear teeth are configured to have a chamfered surface.
